(19) United States
(12) Patent Application Publication
(10) Pub. No.: US 2010/0296637 A1
(43) Pub. Date: Nov. 25, 2010

(54) Service Processing Method, Communication System and Related Device

(75) Inventors: Xuezhi SHEN, Shenzhen (CN); Ruinan SUN, Shenzhen (CN); Wenjie ZHU, Shenzhen (CN); Yongfu YAN, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/782,478

(22) Filed: May 18, 2010

(30) Foreign Application Priority Data
May 19, 2009 (CN) 200910140489.1

(51) Int. Cl. H04M 1/64

(52) U.S. Cl. 379/87

(57) ABSTRACT

Embodiments of this invention disclose a service processing method, a communication system and related device, for making it easier for a user to set up and manage ring personal group, and capable of enhancing system safety. The method comprises: acquiring, by a management client, a ring personal group processing request of a user; and transmitting, by the management client, the ring personal group processing request to a service server over a mobile network, so that the by service server performs the corresponding processing according to the ring personal group processing request. Embodiments of this invention further provide a communication system and related device. Embodiments of this invention make it convenient for the user to set up and manage ring personal group, and make it possible to reduce unnecessary network traffic and enhance system safety.

### CROSS-REFERENCE TO RELATED APPLICATIONS

This application claims priority to Chinese Patent Application No. 200910140489.1, filed on May 19, 2009, which is hereby incorporated by reference in its entirety.

### FIELD OF THE TECHNOLOGY

The present invention relates to the field of communications, and more particularly, to a service processing method, a communication system and related device.

### BACKGROUND OF THE INVENTION

With the development of data service, a variety of personalized services are currently available, for instance, the personalized ring back tone service is a service allowing the terminal user to customize the ring back tone in local.

The personalized ring back tone service is the personalized ring back tone, which is also referred to as the colorful ring back tone, heard by the calling user after the calling terminal initiates a call to a called terminal, the called terminal begins to ring, and before the called user picks up the phone.

This service opens the network capability of the service operator to users to provide service support for the users to display their personality, caters for the intensive demand for modern people to display personality, and is therefore well received in terms of marketing effect.

In the prior art, setup of the personalized ring back tone service is mainly achieved by the user accessing the Internet via a computer and logging in a website designated by the service operator. The user may set up relevant ring personal groups to provide different groups with different rings.

However, since it is necessary to access the Internet via the computer and log in the website designated by the service operator for a user to set up and manage the ring personal groups, the prior art solution makes it inconvenient for users having no computers at hand or incapable of accessing the Internet to set up and manage the ring personal groups in real time.

With the gradual popularization of the Wireless Application Protocol (WAP), there comes another method for direct access to the website designated by the service operator via WAP on the user terminal.

Nevertheless, this requires the corresponding website to be able to generate a corresponding webpage that supports the login of the user terminal, thus increasing complexity and the amount of maintenance at the website. Moreover, if the website is inaccessible (due to malicious attack or routine maintenance, for instance), it is still impossible for the user to set up and manage the ring personal groups.

### SUMMARY OF THE INVENTION

Embodiments of the present invention provide a service processing method, a communication system and related device, making it easy for users to set up and manage the ring personal groups, and making it possible to enhance system safety.

A service processing method according to an embodiment of the present invention comprises: a management client acquiring a ring personal group processing request of a user; and the management client transmitting the ring personal group processing request to a service server over a mobile network, so that the service server performs corresponding processing according to the ring personal group processing request.

A communication system according to an embodiment of the present invention comprises: a management client configured to acquire a ring personal group processing request of a user, and transmit the ring personal group processing request to a service server over a mobile network; and a service server configured to receive the ring personal group processing request transmitted by the management client over the mobile network, and perform processing on a corresponding ring personal group according to the ring personal group processing request.

A management client according to an embodiment of the present invention comprises: a processing request acquiring unit configured to acquire a ring personal group processing request of a user; and a request transmitting unit configured to transmit the ring personal group processing request acquired by the processing request acquiring unit to a service server over a mobile network, so that the service server performs corresponding processing according to the ring personal group processing request.

The service processing device according to an embodiment of the present invention comprises: a request receiving unit configured to receive a ring personal group processing request transmitted by a management client over a mobile network; and a processing unit configured to perform processing on a corresponding ring personal group according to the ring personal group processing request received by the request receiving unit.

As can be seen from the above technical solutions, the embodiments of the present invention have the following advantages: in the embodiments of the present invention, after receiving the ring personal group processing request of the user, the management client directly transmits the ring personal group processing request to the service server over the mobile network without having to log in the website designated by the service operator, so that the direct interaction between the management client and the service server makes it easier for the user to set up and manage the ring personal groups at any time, and the process is not affected by failures of the website.

### BRIEF DESCRIPTION OF THE DRAWINGS

FIG. 1 is a schematic view illustrating an embodiment of the service processing method according to the present invention;

FIG. 2 is a schematic view illustrating an embodiment of the service processing method according to the present invention;

FIG. 3 is a schematic view illustrating another embodiment of the service processing method according to the present invention;

FIG. 4 is a schematic view illustrating yet another embodiment of the service processing method according to the present invention;

FIG. 5 is a schematic view illustrating still another embodiment of the service processing method according to the present invention;

FIG. 6 is a schematic view illustrating an embodiment of the communication system according to the present invention;

FIG. 7 is a schematic view illustrating an embodiment of the management client according to the present invention;

FIG. 8 is a schematic view illustrating an embodiment of the service processing device according to the present invention;

FIG. 9 is a schematic view illustrating an embodiment of an access server according to the present invention; and

FIG. 10 is a schematic view illustrating another embodiment of the access server according to the present invention.

### DETAILED DESCRIPTION OF THE EMBODIMENTS

Embodiments of the present invention provide a service processing method, a communication system and related device, making it easy for users to set up and manage the ring personal groups, and making it possible to enhance system safety.

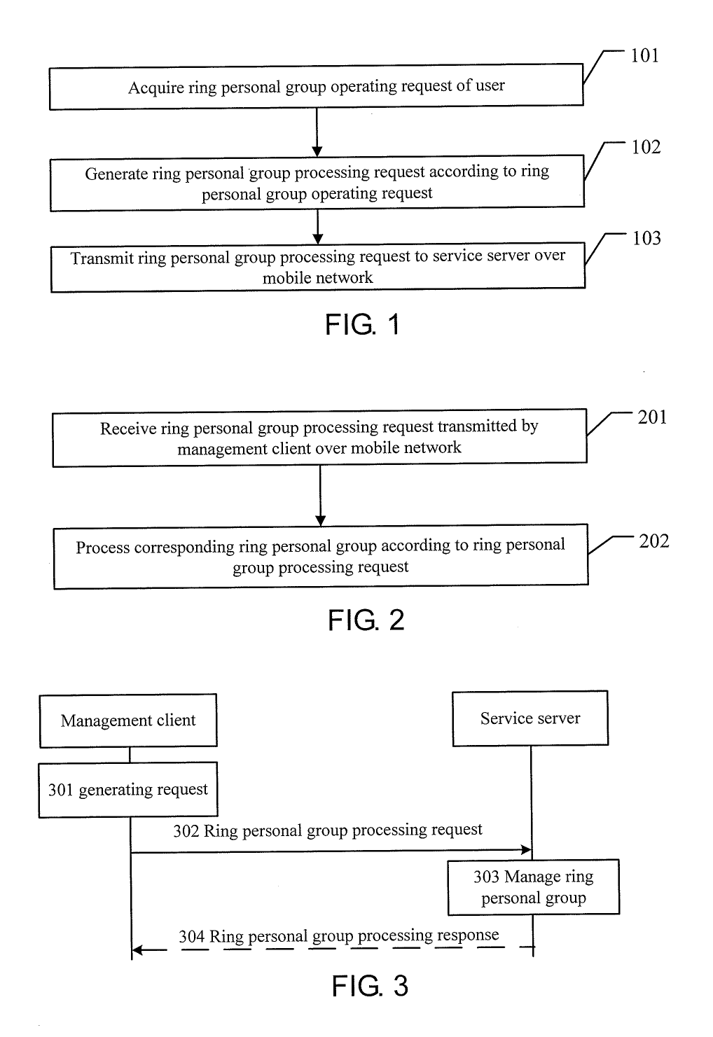

Referring to FIG. 1, an embodiment of the service processing method according to an embodiment of the present invention comprises:

Step 101: acquiring a ring personal group operating request of a user.

When the user intends to set up and manage ring personal groups of his personalized ring service, he may perform such inputting operation as pressing a key according to an operation interface displayed by the management client in the user terminal to send the ring personal group operating request to the management client.

As should be noted, the ring service described in this embodiment includes ring back tone service and ring tone service.

Step 102: generating a ring personal group processing request according to the ring personal group operating request.

Upon reception of the ring personal group operating request from the user, the management client generates a corresponding ring personal group processing request according to the ring personal group operating request. The specific generating process will be described in more detail in subsequent embodiments.

The ring personal group processing request in this embodiment may specifically include:

a ring personal group querying request, for requesting to query the current ring personal group information of the user;

a ring personal group adding request, for requesting to newly create one or more ring personal groups;

a ring group member adding request, for requesting to newly create one or more ring group members in a certain ring personal group;

a ring personal group modifying request, for requesting to modify an already existent ring personal group;

a ring group member modifying request, for requesting to modify the information of one or more ring group members in a certain ring personal group;

a ring personal group deleting request, for requesting to delete an already existent ring personal group, when the ring personal group is deleted, the information of the original ring group member(s) in this ring personal group is deleted altogether; and

a ring group member deleting request, for requesting to delete the information of one or more ring group members in a certain ring personal group.

It can be understood that in practical application the specific ring personal group processing request may include other types, which are not defined here.

As should be noted, the mode whereby the ring personal group operating request is packaged may be different from the mode whereby the ring personal group processing request is packaged, as the ring personal group operating request may be a message transmitted inside the user terminal, while the ring personal group processing request may be a message transmitted between the management client and the service server. In this embodiment, the management client receives the ring personal group operating request inputted by the user from an input module of the user terminal, and subsequently packages the ring personal group operating request to generate the ring personal group processing request.

It can be understood that in practical application, the management client may likewise acquire the ring personal group processing request from the user, in which case the user inputs the ring personal group operating request via the input module of the user terminal, the ring personal group operating request may be packaged by another module, such as a transmission and package module, in the user terminal to generate the ring personal group processing request, and the management client may then obtain the ring personal group processing request of the user.

If the management client directly obtains the ring personal group processing request from the user in Step 101 of this embodiment, Step 102 may not be performed. Here, it is not defined whether the management client should execute in local the process of generating the ring personal group processing request in practical application, and description is made in subsequent embodiments merely by taking such an example that the management client should execute in local the process of generating the ring personal group processing request.

Step 103: transmitting the ring personal group processing request to a service server over a mobile network.

After generation of the ring personal group processing request, the management client may transmit the ring personal group processing request to a service server over a mobile network.

The mobile network in this embodiment may be a Global System for Mobile (GSM) Communications network, a Code Division Multiple Access (CDMA) network, a Wideband Code Division Multiple Access (WCDMA) network, a Time Division-Synchronous Code Division Multiple Access (TD-SCDMA) network, a Code Division Multiple Access 2000 (CDMA2000) network, a Worldwide Interoperability for Microwave Access (WiMax) network, or other mobile networks, the specific types of which are not defined here.

In this embodiment, logic communication ports are created between the management client and the service server, and the logic communication port in the management client may invoke the physical port of the user terminal to communicate with the service server. Specific communication between the management client and the service server is carried out in the application layer, for instance in a General Packet Radio Service (GPRS) network, and data sent from the management client arrives at the service server over the Gateway General Packet Radio Service Support Node (GGSN) and the Serving General Packet Radio Service Support Node (SGSN). The above merely takes an example to describe the communication process between the management client and the service server. It can be understood that, insofar as different mobile networks are concerned in practical application, the communication processes between the management client and the service server as well as the network elements over which the communication passes may be different from each other, and no specific definition is made here.

As should be noted, the management client in this embodiment may be placed in the user terminal, and uses the mobile network to transmit data to the service server by invoking the communication port of the user terminal. The management client is either pre-configured with the network address of the service server or obtains the network address of the service serve in advance, so as to be able to transmit the data according to the address.

In this embodiment, upon reception of the ring personal group operating request from the user, the management client directly transmits the corresponding ring personal group processing request to the service server over the mobile network without having to log in the website designated by the service operator, so that the direct interaction between the management client and the service server makes it easier for the user to set up and manage the ring personal groups at any time, and the process is not affected by failures of the website.

Moreover, the prior art makes use of the WAP to still access the Internet to log in the website designated by the service operator, and this leads to the possibility that the information of the user might be stolen due to insecurity of the Internet.

In this embodiment, the management client interacts with the service server over the mobile network without creating Internet connection with the service server, and since the characteristics of the mobile network itself decide that the safety of the mobile network is higher than that of the Internet, the mode of setting up and managing the ring personal groups over the mobile network in this embodiment effectively enhances system safety.

Furthermore, in the prior art the user terminal directly accesses the website via WAP, and the website will transmit to the terminal such information as recommended rings and webpage pictures that are irrelevant to the setup and management of the ring personal groups, thus generating unnecessary network traffic.

By contrast, in this embodiment, since the management client and the service server directly communicate without having to access the website, the management client will not receive from the service server any information irrelevant to the setup and management of the ring personal groups, thus reducing unnecessary network traffic.

The above starts from the perspective of the management client to describe the service processing method according to an embodiment of the present invention, while the following starts from the perspective of the service server to describe the service processing method according to an embodiment of the present invention. Referring to FIG. 2, an embodiment of the service processing method according to an embodiment of the present invention includes:

Step 201: receiving the ring personal group processing request transmitted from the management client over the mobile network.

In this embodiment, since the management client is preset with the network address of the service server, the management client may transmit the ring personal group processing request to the service server over the mobile network, and the service server in this embodiment may receive the ring personal group processing request transmitted by the management client from a corresponding network element, such as the Serving General Packet Radio Service Support Node (SGSN).

In this embodiment, the ring personal group processing request received by the service server is the same as the ring personal group processing request transmitted by the management client, so that no repetition thereof is made here.

Step 202: processing the corresponding ring personal group according to the ring personal group processing request.

Upon reception of the ring personal group processing request, the service server may process the corresponding ring personal group of the user according to the request, including querying ring personal group information, newly creating ring personal group, newly creating ring group member, modifying ring personal group information, modifying ring group member information, deleting ring personal group, deleting ring group member, or processing in other ways.

As should be noted, prior to processing the corresponding ring personal group, the service server may additionally authenticate the user, parse the corresponding ring personal group processing request after the authentication is passed, and process the corresponding ring personal group according to the parameters carried with the ring personal group processing request.

In this embodiment, besides authenticating the user, in accordance with the specific authentication policy of the service operator, the service server may simultaneously authenticate the user terminal and/or the management client, or authenticate any two of the user, the management client and the user terminal, or authenticate all of these three to execute subsequent operations after the authentication is passed.

In this embodiment, the service server may receive the ring personal group processing request transmitted by the management client over the mobile network, and perform the corresponding processing, so that the direct interaction between the management client and the service server makes it easier for the user to set up and manage the ring personal groups at any time, and the process is not affected by failures of the website.

Moreover, since the management client and the service server directly communicate without having to access the website, the management client will not receive from the service server any information irrelevant to the setup and management of the ring personal groups, thus reducing unnecessary network traffic.

Furthermore, the service server interacts with the management client over the mobile network rather than over Internet connection in this embodiment, and since the characteristics of the mobile network itself decide that the safety of the mobile network is higher than that of the Internet, the mode of setting up and managing the ring personal groups over the mobile network in this embodiment effectively enhances system safety.

To facilitate comprehension, the following start from the perspective of the interaction between the management client and the service server to describe in detail the service processing method according to an embodiment of the present invention. Referring to FIG. 3, another embodiment of the service processing method according to an embodiment of the present invention includes:

Step 301: The management client generates a ring personal group processing request.

In this embodiment, when the user intends to set up and manage ring personal groups of his personalized ring service, he may firstly log in the management client, which may be a software in the user terminal, and after the management client passes the user authentication, the user performs such inputting operation as pressing a key to send the ring personal group operating request to the management client in the user terminal.

As should be noted, the ring service described in this embodiment includes ring back tone service and ring tone service.

After acquiring the ring personal group operating request, the management client generates the corresponding ring personal group processing request according to the ring personal group operating request. The specific generating process may employ one of the following modes:

### A. Via Hyper Text Transfer Protocol (HTTP):

In this mode, the management client carries the parameters of the ring personal group operating request in the message header or message body of the HTTP message, which serves as the ring personal group processing request.

As should be noted, if the parameters of the ring personal group operating request are directly described in the mode of character strings, the parameters of the ring personal group operating request may be carried in the message header or message body of the HTTP message.

However, if the parameters of the ring personal group operating request are described in the mode of eXtensible Markup Language (XML) or Simple Object Access Protocol (SOAP), the parameters of the ring personal group operating request may be carried in the HTTP message body.

### B. Via XML Configuration Access Protocol (XCAP):

In this mode, the management client should possess the function of the XCAP client, capable of generating an XCAP command in the XCAP message format, namely the ring personal group processing request, in line with XCAP.

As should be noted, the aforementioned two modes are merely specific modes of execution proposed in this embodiment, while different protocols may be used to generate the ring personal group processing request on demand of specific transmission requirements in practical application, and the specific types of the protocols and the generating processes thereof are not defined here.

The ring personal group processing request in this embodiment is of the same type as that of the ring personal group processing request in the embodiment illustrated in FIG. 2, so that no repetition thereof is made here.

The user may set different rings for use by ring group members in different ring personal groups.

Step 302: The management client transmits the generated ring personal group processing request to the service server via the mobile network.

In this embodiment, after generating the ring personal group processing request, the management client may transmit the ring personal group processing request to the service server via the mobile network, and the specific mobile network may be a GSM network, or a CDMA network, or any other mobile networks, whose specific types are not defined here.

As should be noted, the management client in this embodiment may be placed in the user terminal, and uses the mobile network to transmit data to the service server by invoking the communication port of the user terminal. The management client is either pre-configured with the network address of the service server or obtains the network address of the service server in advance, so as to be able to transmit the data according to the address.

Step 303: The service server performs corresponding processing according to the received ring personal group processing request.

In this embodiment, since the management client is pre-configured with the network address of the service server, the management client may transmit the ring personal group processing request to the service server over the mobile network, and the service server in this embodiment may receive the ring personal group processing request transmitted from a corresponding network element, such as SGSN.

Upon reception of the ring personal group processing request, the service server may further authenticate the user, and/or the user terminal, and/or the management client prior to processing the corresponding ring personal group, and perform processing according to the ring personal group processing request after the authentication is passed.

The process for the service server to perform processing on the corresponding ring personal group according to the ring personal group processing request will be described in greater detail in subsequent embodiments.

Step 304: The service server feeds back a ring personal group processing response to the management client over the mobile network.

In this embodiment, upon completion of processing the ring personal groups of the user, the service server may feed back the processing response to the management client, for instance, by feeding back the processing result, alternatively, when the user requests to browse the ring personal groups, the service server feeds back the information of the current ring personal group of the user to the management client.

As should be noted, Step 304 in this embodiment is optional, as the service server is not necessarily to feed back the processing result to the management client, for instance, when the user requests to delete a certain ring personal group, it suffices for the service server to delete the corresponding ring personal group according to the request without having to feed back the processing result.

Besides possessing the same advantageous effects as those of the embodiments illustrated in FIGS. 1 and 2, the technical solution of this embodiment further has the advantageous effect in the fact that the management client may generate the ring personal group processing request in a variety of modes, thereby adapting to a plurality of transmission protocols, and enhancing the flexibility of transmitting the ring personal group processing request.

In practical application, the specific ring personal group processing request may include any one of a ring personal group querying request, a ring personal group adding request, a ring group member adding request, a ring personal group modifying request, a ring group member modifying request, a ring personal group deleting request, and a ring group member deleting request. To facilitate comprehension, these types of specific requests are respectively taken as examples below to describe. The service processing method in this embodiment may be divided into the following circumstances depending on the different mode of generating the ring personal group processing request:

### A. Service Processing Under the Http Mode:

### (1) The Process of Processing the Ring Personal Group Querying Request:

In this mode, when the user intends to query the already existent ring personal groups of his own, he may input a ring personal group operating request to the management client, and the management client generates a corresponding ring personal group querying request, which may include the following parameter: user identifier;

The user identifier is the identifier of the user who initiates the ring personal group operating request.

In practical application, the ring personal group querying request may include more parameters, which may specifically be as follows.

TABLE 1

| | | Whether | |
|---|---|---|---|
| | | may be | |
| Parameter Name | Composition | null | Explanations |
| identifier | Number or | No | User number, which may be the |
| (e.g., userid) | URI | | phone number or Mobile Station |
| | | | international Integrated Service |
| | | | Digital Network (MSISDN) number |
| | | | of the user |
| User access code | number, letter | Yes | User access code |
| (e.g., randomsessionkey) | | | |
| Equipment identifier | number | Yes | Equipment number, which may be |
| (e.g., sid) | | | International Mobile Equipment |
| | | | Identity (IMEI) number of the user |
| | | | terminal |
| Group identifier | Number or | Yes | When the user intends to query a |
| (e.g., groupid) | URI | | certain designated ring personal |
| | | | group, he may fill in the group |
| | | | identifier of the ring personal group |
| | | | desired to be queried |
| Group name | character | Yes | When the user intends to query a |
| (e.g., groupname) | | | certain designated ring personal |
| | | | group, he may fill in the group |
| | | | name of the ring personal group |
| | | | desired to be queried |
| Member number | Number or | Yes | When the user intends to query a |
| (e.g., membernumber) | URI | | certain ring group member in a |
| | | | certain designated ring personal |
| | | | group, he may fill in the member |
| | | | number of the ring group member |
| | | | desired to be queried |

The parameters shown in the above Table 1 are merely specific modes of execution in this embodiment, as in practical application other types of parameters may be further added, while the specific parameters are not defined here.

The management client may generate the corresponding ring personal group querying request according to HTTP, for instance, with reference to the parameter structure in Table 1, in practical application the specific ring personal group querying request may be “http://10.70.119.108:80/spservice/querygroup.do?userid=13800”.

The ring personal group querying request includes the address and the port “10.70.119.108:80” of the service server, the type of the request “query”, and the user identifier “userid=13800”. The ring personal group querying request is generated in the message head of the HTTP message in the form of a character string, while the specific mode of placing it in the message body and the mode of using the XML description are similar, and is hence not repeated here.

Once the ring personal group querying request is transmitted to the corresponding service server through the port of the management client and over the mobile network, the service server performs the corresponding querying operation, and returns to the management client the querying result, which contains the information of the ring personal group of the user with user identifier of 13800.

In this embodiment, the information of the ring personal group returned by the service server may be described in the form of XML, for instance:

<?xml version=“1.0” encoding=“GBK”?>
<!ELEMENT personalgroup (group* )| returncode >
<!ELEMENT group(name+,value+)>
<!-parameter name, groupid(ring personal group number) and
groupname(ring personal group name) -->
<!ELEMENT name (#PCDATA)>
<!-parameter value-->
<!ELEMENT value (#PCDATA)>
<!-error code-->
<!ELEMENT returncode (#PCDATA)>

If the user has already set up two ring personal groups, the information of the ring personal groups received by the terminal will be as follows:

<?xml version=“1.0” encoding=“GBK” ?>
<personalgroup>
<groups>
<group>
<name>groupid</name>
<value>1115</value>
<name>groupname</name>
<value>124</value>
</group>
<group>
<name>groupid</name>
<value>1116</value>
<name>groupname</name>
<value>124tt</value>
</group>
</groups>
</personalgroup>

What is described above is that the user requests to query the information of all of his own ring personal groups; if what is queried by the user is a ring group member in a certain ring personal group, the specific ring personal group querying request may be: “http://10.70.119.108:80/spservice/querygroup.do?userid=13800&groupid=1115”.

Then the service server queries the information of all ring group members in the ring personal group with the group identifier of 1115, including the member name and/or the member number, and returns the querying result.

For instance, if the ring personal group with the group identifier of 1115 as the user requests to query has two users, namely user 11 whose number is 13511111111 and user 1jj whose number is 13511122111, the ring group member information carried in the returned message will be as follows:

<?xml version=“1.0” encoding=“GBK” ?>
<personalgroupmember>
<groupmembers>
<groupmember>
<name>membernumber</name>
<value>13511111111</value>
<name>membername</name>
<value>11</value>
</groupmember>
<groupmember>
<name>membernumber</name>
<value>13511122111</value>
<name>membername</name>
<value>1jj</value>
</groupmember>
</groupmembers>
</personalgroupmember>

As should be noted, if the user does not set up the ring personal group, or the ring group member desired to be queried does not exist, the returned message may notify the management client by carrying therewith an error code, while the specific error code and the mode of carrying the code are not defined here.

As should be noted, in this embodiment under the mode of HTTP, the result returned by the service server may be directly transmitted to the management client via HTTP, and may also be downloaded by the management client for the corresponding ring personal group document, while the specific mode is not defined here.

As should be noted, in this embodiment the user acquires the ring personal group information from the service server by the mode of voluntarily initiating the querying request, while in practical application it is also possible for the service server to synchronize the ring personal group information of the user to the management client under a certain trigger condition or periodically, for instance, the service server and the management client may negotiate to synchronize once a week the ring personal group information of the user; alternatively, after the user has logged in the website designated by the service operator through a computer to modify the ring personal group information, the service server may also initiatively synchronize the ring personal group information to the management client, in which case the management client may present the user with the synchronized ring personal group information, and the user may also directly query the current ring personal group information of his own through the management client without having to transmit a querying request.

### (2) The Process of Processing the Ring Personal Group Adding Request:

In this mode, when the user intends to newly add one ring personal group, he inputs a ring personal group operating request to the management client, and the management client generates a corresponding ring personal group adding request, which may include the following parameters: user identifier and addition identifier.

The addition identifier in this embodiment may include the group identifier and/or the group name.

The user identifier is the identifier of the user who initiates the ring personal group operating request, the group identifier is an addition group identifier, namely the identifier of the ring personal group desired to be newly added by the user, and the group name is an addition group name, namely the name of the ring personal group desired to be newly added by the user.

As should be noted, in practical application the group identifier and the group name may be carried with one, or both of the two, or none of the two. The group identifier and the group name may be automatically generated by the service server according to preset rules.

In practical application, the ring personal group adding request may include more parameters, which may specifically be as follows:

TABLE 2

| | | Whether may | |
|---|---|---|---|
| Parameter Name | Composition | be null | Explanations |
| User identifier | Number or | No | User number, which may be |
| (e.g., userid) | URI | | mobile phone number or |
| | | | MSISDN number of the user |
| User access code | number, letter | Yes | User access code |
| (e.g., randomsessionkey) | | | |
| Equipment identifier | number | Yes | Equipment number, which may |
| (e.g., sid) | | | be IMEI number of the user |
| | | | terminal |
| Group identifier | Number or | Yes | Group identifier, which may be |
| (e.g., groupid) | URI | | several, of the ring personal |
| | | | group desired to be newly |
| | | | added by the user |
| Group name | character | Yes | Group name of the ring |
| (e.g., groupname) | | | personal group desired to be |
| | | | newly added by the user |
| Group description | character | Yes | Descriptive information of the |
| (e.g., groupdescription) | | | group |

Upon acquisition of the ring personal group operating request, the management client generates the corresponding ring personal group adding request according to HTTP. It is supposed that the group identifier in this embodiment is set up by the management client in local, then the specific ring personal group adding request may be “http://10.70.119.108:80/spservice/addgroup.do?userid=13800&groupid=110”.

After the ring personal group adding request is transmitted to the corresponding service server through the port of the management client and over the mobile network, the service server may create a new ring personal group according to the addition group identifier, namely newly add a ring personal group with the group identifier of 110 under the user with the user identifier of 13800 according to the received ring personal group adding request.

What is described above is directed to the circumstance of adding one ring personal group, while It can be understood that it is also possible in practical application to simultaneously add a plurality of groups if the ring personal group adding request carries therewith a plurality of group identifiers.

It can be understood that upon completion of adding the ring personal group, the service server may also return the processing result to the management client. The specific processing result may include an identifier indicative of whether the operation is successful and the cause of operation failure, for instance, 0 is used to indicate that the operation is successful, and other different numbers are used to indicate: that the user is invalid, that the group number is repetitive, and that the number of groups exceeds the maximum number, etc. The specific processing result may be carried in the HTTP message body in the form of XML, as shown below:

<?xml version=”1.0” encoding=”GBK”?>
<!ELEMENT addgroup (returncode)|returncode>
<!-resultcode-->
<!ELEMENT returncode (#PCDATA)>

if group is successfully added:

<?xml version=”1.0” encoding=”GBK”?>
<addgroup>
<returncode>0</ returncode>
</addgroup>

operation failure:

<xml version=“1.0” encoding=“GBK”?>
<returncode>(cause of operaton failure)</returncode>

### (3) The Process of Processing the Ring Group Member Adding Request:

In this mode, when the user intends to newly add a ring group member in a certain ring personal group, he inputs a ring personal group operating request to the management client, and the management client generates a corresponding ring group member adding request, which may include the following parameters: user identifier, addition identifier.

The addition identifier in this embodiment may include the group identifier, the member type, the member name and the member number.

The user identifier is the identifier of the user who initiates the ring personal group operating request, the group identifier is an addition group identifier, namely the identifier of the ring personal group of the ring group member intended by the user to be newly added, the member type is an addition member type, namely the member type of the ring group member intended by the user to be newly added, the member name is an addition member name, namely the member name of the ring group member intended by the user to be newly added, and the member number is an addition member number, namely the member number of the ring group member intended by the user to be newly added.

In practical application, the ring group member adding request may include more parameters, which may specifically be as follows:

TABLE 3

| | | Whether | |
|---|---|---|---|
| Parameter Name | Composition | may be null | Explanations |
| User identifier | Number or URI | No | User number, which may be |
| (e.g., userid) | | | mobile phone number or |
| | | | MSISDN number of the user |
| User access code | number, letter | Yes | User access code |
| (e.g., | | | |
| randomsessionkey) | | | |
| Equipment identifier | number | Yes | Equipment number, which may |
| (e.g., sid) | | | be IMEI number of the user |
| | | | terminal |
| Group identifier | Number or URI | No | Group identifier of the ring |
| (e.g., groupid) | | | personal group of the ring |
| | | | group member intended to be |
| | | | newly added by the user |
| Member type | number | Yes | Member type: |
| (e.g., membertype) | | | mobile phone |
| | | | set phone |
| | | | 2-other types |
| Member name | character | Yes | Member names, separated by |
| (e.g., membername) | | | “\|” if many |
| Member number | Number or URI | No | Member numbers, separated by |
| (e.g., membernumber) | | | “\|” if many |
| Member description | character | Yes | Member details, separated by |
| (e.g., memberdetails) | | | “\|” if many; |
| | | | inputting “space” for any null |
| | | | in the details |

Upon acquisition of the ring personal group operating request, the management client generates the corresponding ring group member adding request according to HTTP. In practical application, the specific ring group member adding request may be “http://10.70.119.108:80/spservice/addgroupmember.do?userid=13800&groupid=110&membertype=0&membemame=1111&membernumber=13801”.

After the ring group member adding request is transmitted to the corresponding service server through the port of the management client and over the mobile network, the service server may create a new ring group member according to the addition member type, the addition member name and the addition member number, namely newly add a ring group member with the member type of “mobile phone”, the member name of “1111” and the member number of “13801” in the ring personal group with the group identifier of 110 under the user with the user identifier of 13800 according to the received ring group member adding request.

It can be understood that upon completion of adding the ring group member, the service server may also return the processing result to the management client. The specific processing result may include an identifier indicative of whether the operation is successful and the cause of operation failure, for instance, 0 is used to indicate that the operation is successful, and other different numbers are used to indicate: that the user is invalid, that the member number is repetitive, and that the number of members exceeds the maximum value, etc. The specific processing result may be carried in the HTTP message body in the form of XML, as shown below:

<?xml version=”1.0” encoding=”GBK”?>
<addpersonagroupmember>
<member>
<name>membernumber</name>
<value>13801</value>
<name>result</name>
<value>0</value> adding user 13801 succeed
</member>
</addpersonalgroupmember>

### (4) The Process of Processing the Ring Personal Group Modifying Request:

In this mode, when the user intends to modify a ring personal group, he inputs a ring personal group operating request to the management client, and the management client generates a corresponding ring personal group modifying request, which may include the following parameters: a user identifier, an modify identifier and a target modifier.

The modify identifier in this embodiment may include the identifier of the group to be modified, and the target identifier in this embodiment may include the target group name.

The user identifier is the identifier of the user who initiates the ring personal group operating request, the identifier of the group to be modified is the identifier of the group to be modified, namely the identifier of the ring personal group intended to be modified by the user, and the target group name is the name of the modified ring personal group intended by the user.

In practical application, the ring personal group modifying request may include more parameters, which may specifically be as follows:

TABLE 4

| | | Whether | |
|---|---|---|---|
| Parameter Name | Composition | may be null | Explanations |
| User identifier | Number or | No | User number, which may be |
| (e.g., userid) | URI | | mobile phone number or |
| | | | MSISDN number of the user |
| User access code | number, letter | Yes | User access code |
| (e.g., randomsessionkey) | | | |
| Equipment identifier | number | Yes | Equipment number, which |
| (e.g., sid) | | | may be IMEI number of the |
| | | | user terminal |
| Group identifier | Number or | No | Group identifier of the ring |
| (e.g., groupid) | URI | | personal group intended to be |
| | | | modified by the user |
| Target group name | character | Yes | Target group name of the ring |
| (e.g., tgroupname) | | | personal group intended by |
| | | | the user |
| Target group description | character | Yes | Descriptive information of |
| (e.g., tgroupdescription) | | | the group |

Upon acquisition of the ring personal group operating request, the management client generates the corresponding ring personal group modifying request according to HTTP, which request may include the user identifier, the identifier of the group to be modified and the target group name. In practical application, the specific ring personal group modifying request may be “http://10.70.119.108:80/spservice/modifygroup.do?userid=13800&groupid=110&tgroupname=1000”.

After the ring personal group modifying request is transmitted to the corresponding service server through the port of the management client and over the mobile network, the service server may query to acquire the corresponding group to be modified according to the identifier of the group to be modified, and modify the group name of the group to be modified to the target group name, i.e., the service server modifies the group name of the ring personal group with the original group identifier of 110 under the user with the user identifier of 13800 to 1000.

It can be understood that upon completion of modifying the ring personal group, the service server may also return the processing result to the management client. The specific processing result may include an identifier indicative of whether the operation is successful and the cause of operation failure, for instance, 0 is used to indicate that the operation is successful, and other different numbers are used to indicate: that the user is invalid, that the group name is repetitive, and that the group does not exist, etc. The specific processing result may be carried in the HTTP message body in the form of XML, while the specific form is not defined here.

### (5) The Process of Processing the Ring Group Member Modifying Request:

In this mode, when the user intends to modify a ring group member in a certain ring personal group, he inputs a ring personal group operating request to the management client, and the management client generates a corresponding ring group member modifying request, which may include the following parameters: a user identifier, an modify identifier and a target modifier.

The modify identifier in this embodiment may include the group identifier and the member number, and the target identifier in this embodiment may include the target member number, the target member type, and the target member name.

The user identifier is the identifier of the user who initiates the ring personal group operating request, the group identifier is the identifier of the ring personal group of the ring group member intended to be modified by the user, the member number is the number of the member to be modified, namely the member number of the ring group member intended to be modified by the user, the target member number is the member number of the modified ring group member intended by the user, the target member type is the member type of the modified ring group member intended by the user, and the target member name is the member name of the modified ring group member intended by the user.

In practical application, the ring group member modifying request may include more parameters, which may specifically be as follows:

TABLE 5

| | | Whether may | |
|---|---|---|---|
| Parameter Name | Composition | be null | Explanations |
| User identifier | Number or | No | User number, which may be |
| (e.g., userid) | URI | | mobile phone number or |
| | | | MSISDN number of the user |
| User access code | number, letter | Yes | User access code |
| (e.g., | | | |
| randomsessionkey) | | | |
| Equipment identifier | number | Yes | Equipment number, which |
| (e.g., sid) | | | may be IMEI number of the |
| | | | user terminal |
| Group identifier | Number or | No | Group identifier of the ring |
| (e.g., groupid) | URI | | personal group of the ring |
| | | | group member intended to be |
| | | | modified by the user |
| Member number | Number or | No | Member number of the ring |
| (e.g., membernumber) | URI | | group member to be modified |
| Target member number | character | Yes | Member number of the |
| (e.g., tmembernumber) | | | modified ring group member |
| | | | intended by the user |
| Target member type | number | Yes | Member type of the modified |
| (e.g., tmembertype) | | | ring group member intended |
| | | | by the user |
| | | | mobile phone |
| | | | set phone |
| | | | 2-other types |
| Target member name | character | Yes | Member name of the |
| (e.g., tmembername) | | | modified ring group member |
| | | | intended by the user |

Upon acquisition of the ring personal group operating request, the management client generates the corresponding ring group member modifying request according to HTTP. In practical application, the specific ring group member modifying request may be “http://10.70.119.108:80/spservice/modifygroupmember.do?userid=13800&groupid=110&membernumber=13801&tmembernumber=13802&tmembertype=1&tmembername=9999”.

After the ring group member modifying request is transmitted to the corresponding service server through the port of the management client and over the mobile network, the service server may query to obtain the corresponding member to be modified in the ring personal group according to the number of the member to be modified, modify the member number of the member to be modified to the target member number, modify the member name of the member to be modified to the target member name, and modify the member type of the member to be modified to the target member type; that is to say, the service server queries the member to be modified with the member number of 13801 in the ring personal group with the group identifier of 110 under the user with the user identifier of 13800, modifies the member number of the member to be modified to 13802, modifies the member type of the member to be modified to set phone, and modifies the member name of the member to be modified to 9999.

It can be understood that upon completion of modifying the ring group member, the service server may also return the processing result to the management client. The specific processing result may include an identifier indicative of whether the operation is successful and the cause of operation failure, for instance, 0 is used to indicate that the operation is successful, and other different numbers are used to indicate: that the user is invalid, that the ring group member does not exist, and that the member number is repetitive, etc. The specific processing result may be carried in the HTTP message body in the form of XML, while the specific form is not defined here.

### (6) The Process of Processing the Ring Personal Group Deleting Request:

In this mode, when the user intends to delete a ring personal group, he inputs a ring personal group operating request to the management client, and the management client generates a corresponding ring personal group deleting request, which may include the following parameters: a user identifier, and a deletion identifier.

The deletion identifier in this embodiment may include a group identifier.

The user identifier is the identifier of the user who initiates the ring personal group operating request, and the group identifier is the identifier of the group to be deleted, namely the identifier of the ring personal group intended to be deleted by the user.

In practical application, the ring personal group deleting request may include more parameters, which may specifically be as follows:

TABLE 6

| | | Whether | |
|---|---|---|---|
| | | may be | |
| Parameter Name | Composition | null | Explanations |
| User identifier | Number or | No | User number, which may be |
| (e.g., userid) | URI | | mobile phone number or |
| | | | MSISDN number of the user |
| User access code | number, letter | Yes | User access code |
| (e.g., randomsessionkey) | | | |
| Equipment identifier | number | Yes | Equipment number, which may |
| (e.g., sid) | | | be IMEI number of the user |
| | | | terminal |
| Group identifier | Number or | No | Group identifier of the ring |
| (e.g., groupid) | URI | | personal group intended to be |
| | | | deleted by the user |

Upon acquisition of the ring personal group operating request, the management client generates the corresponding ring personal group deleting request according to HTTP. In practical application, the specific ring personal group deleting request may be “http://10.70.119.108:80/spservice/delgroup.do?userid=13800&groupid=110”.

After the ring personal group deleting request is transmitted to the corresponding service server through the port of the management client and over the mobile network, the service server may query to obtain the corresponding group to be deleted according to the identifier of the group to be deleted, and delete the group to be deleted as well as the ring group member(s) in the group; that is to say, the service server deletes the ring personal group with the group identifier of 110 as well as the ring group member(s) in this ring personal group under the user with the user identifier of 13800.

It can be understood that upon completion of deleting the ring personal group, the service server may also return the processing result to the management client. The specific processing result may include an identifier indicative of whether the operation is successful and the cause of operation failure, for instance, 0 is used to indicate that the operation is successful, and other different numbers are used to indicate: that the user is invalid, that the group identifier is null, and that the group does not exist, etc. The specific processing result may be carried in the HTTP message body in the form of XML, as shown below:

<?xml version=“1.0” encoding=“GBK”?>
<!ELEMENT delpersonagroup (group*)|returncode>
<!ELEMENT group (name+,value+)>
<!-parametername , groupid (groupnumber) result ( returncode ) -->
<!ELEMENT name (#PCDATA)>
<!-parametervalue-->
<!ELEMENT value (#PCDATA)>

if operation is successful:

<?xml version=”1.0” encoding=”GBK”?>
<delpersonagroup>
<group>
<name>groupid</name>
<value>110</name>
<name>result</name>
<value>0</value>
</group>
</delpersonagroup>

operation fails:

<xml version=“1.0” encoding=“GBK”?>
<returncode>(cause of operation failure)</returncode>

### (7) The Process of Processing the Ring Group Member Deleting Request:

In this mode, when the user intends to delete a certain ring group member from a certain ring personal group, he inputs a ring personal group operating request to the management client, and the management client generates a corresponding ring group member deleting request, which may include the following parameters: a user identifier, and a deletion identifier.

The deletion identifier in this embodiment may include the group identifier and the member number.

The user identifier is the identifier of the user who initiates the ring personal group operating request, the group identifier is the identifier of the ring personal group of the ring group member intended to be deleted by the user, and the member number is the number of the member to be deleted, namely the member number of the ring group member intended to be deleted by the user.

In practical application, the ring group member deleting request may include more parameters, which may specifically be as follows:

TABLE 7

| | | Whether | |
|---|---|---|---|
| Parameter Name | Composition | may be null | Explanations |
| User identifier | Number or | No | User number, which may be |
| (e.g., userid) | URI | | mobile phone number or |
| | | | MSISDN number of the user |
| User access code | number, letter | Yes | User access code |
| (e.g., randomsessionkey) | | | |
| Equipment identifier | number | Yes | Equipment number, which |
| (e.g., sid) | | | may be IMEI number of the |
| | | | user terminal |
| Group identifier | Number or | No | Group identifier of the ring |
| (e.g., groupid) | URI | | personal group of the ring |
| | | | group member intended to be |
| | | | deleted by the user |
| Member number | Number or | No | Member number, which may |
| (e.g., membernumber) | URI | | be many, of the ring group |
| | | | member intended to be |
| | | | deleted by the user |

Upon acquisition of the ring personal group operating request, the management client generates the corresponding ring group member deleting request according to HTTP. In practical application, the specific ring group member deleting request may be “http://10.70.119.108:80/spservice/delgroupmember.do?userid=13800&groupid=110&membernumber=13801”.

After the ring group member deleting request is transmitted to the corresponding service server through the port of the management client and over the mobile network, the service server may query to obtain the corresponding member to be deleted from the corresponding ring personal group according to the identifier of the group to be deleted and the number of the member to be deleted, and delete the member to be deleted from the ring personal group; that is to say, the service server queries and deletes the member to be deleted with the member number of 13801 in the ring personal group with the group identifier of 110 under the user with the user identifier of 13800 according to the received ring group member deleting request.

As should be noted, the above ring group member deleting request carries therewith only one number of the member to be deleted, and the service server deletes the information of the ring group member to which the member number corresponds. It can be understood that, it is also possible in practical application for the ring group member deleting request to carry therewith a plurality of numbers of the members to be deleted, in which case the service server simultaneously deletes a plurality of corresponding ring group members.

It can be understood that, upon completion of deleting the ring group member, the service server may also return the processing result to the management client. The specific processing result may include an identifier indicative of whether the operation is successful and the cause of operation failure, for instance, 0 is used to indicate that the operation is successful, and other different numbers are used to indicate: that the user is invalid, and that the ring group member cannot be deleted, etc. The specific processing result may be carried in the HTTP message body in the form of XML, as shown below:

<?xml version=“1.0” encoding=“ GBK ” ?>
<delpersonagroupmember>
<member>
<name>membernumber</name>
<value>13801</name>
<name>result</name>
<value>0</value>
</member>
</delpersonagroupmember >

In the above embodiments, descriptions are made respectively to the processing processes of the ring personal group querying request, the ring personal group adding request, the ring group member adding request, the ring personal group modifying request, the ring group member modifying request, the ring personal group deleting request, and the ring group member deleting request. It can be understood that, the specific ring personal group processing request may be other types of requests in practical application, while the specific types are not defined here.

### B. Service Processing Under the XCAP Mode:

The above describes the service processing under the HTTP mode, while the following presents the service processing under the XCAP mode. When XCAP is used, it is required that both the management client and the service server support the XCAP, and the service server should possess the function of an XCAP server to store and manage the information of ring personal group using the form of XML document. In this mode, it is easier for the management client to modify a certain specific setup item, and information data transmitted between the management client and the service server is relatively few, thereby further reducing unnecessary network traffic.

As should be firstly noted, in this mode, the service server manages the XML document of the ring personal group information of a certain user in a treelike configuration according to XCAP rule; for instance, with regard to a user Tom, it may be considered that the XCAP resource address of the specific ring personal group information of this user is http://server.crbt.com/service-setting/users/Tom/personalgroup1, indicating that the root address of the service is server.crbt.com, the application identifier is service-setting, the user identifier is Tom, and the XML document of the ring personal group information is personalgroup1; for instance, the specific ring personal group information may be as follows:

<?xml version=″1.0″ encoding=″GBK″?>
<groupset>
<group groupid=”110”>
<groupmembers>
<groupmember membernumber =”13801”>
< membername >11</ membername >
</groupmember>
<groupmember membernumber =” 13802”>
< membername >1jj</ membername >
< memberdetail >Important customer</ memberdetail >
</groupmember>
</groupmembers>
</group>
</groupset>

The above ring personal group information indicates that the user Tom has set a group with the group identifier of 110, and that the group contains two ring group members, with the member number of the first ring group member being 13801, the member name being 11, and with the member number of the second ring group member being 13802, the member name being 1jj, and the member description being Important customer.

Respective processing processes are described below also according to the different ring personal group processing requests.

(1) The Process of Processing the Ring Personal Group Querying Request:

In this mode, when the user intends to query the already existent ring personal groups of his own, he may input a ring personal group operating request to the management client, and the management client generates a corresponding ring personal group querying request.

Upon acquisition of the ring personal group operating request, the management client generates a corresponding ring personal group querying request according to XCAP, and the specific ring personal group querying request may be “GET http://server.crbt.com/service-setting/users/Tom/personalgroup1 HTTP/1.1”, where “GET” indicates acquisition.

After the ring personal group querying request is transmitted to the corresponding service server through the port of the management client and over the mobile network, the service server performs the corresponding querying operation, and returns the querying result, which may specifically be the XML document of the ring personal group personalgroup1 of the user, to the management client.

What is queried in the example above is the information of all ring personal groups in personalgroup1 of the user. As should be noted, it is also possible in practical application to query the information of only one ring personal group:

GET
http://server.crbt.com/service-setting/users/Tom/personalgroup1/~~/
group[groupid=“110”] HTTP/1.1

Then, the response message returned by the server to the management terminal is HTTP/1.1 200 OK, and the message body carries therewith the information of the ring personal group with the group identifier of 110, for instance:

<group groupid=”110”>
<groupmembers>
<groupmember membernumber =”13801”>
< membername >11</ membername >
</groupmember>
<groupmember membernumber =” 13802”>
< membername >1jj</ membername >
< memberdetail >Important customer</ memberdetail >
</groupmember>
</groupmembers>
</group>

(2) The Process of Processing the Ring Personal Group Adding Request:

In this mode, when the user intends to newly add a ring personal group, he inputs a ring personal group operating request to the management client, and the management client generates a corresponding ring personal group adding request.

Upon acquisition of the ring personal group operating request, the management client generates a corresponding ring personal group adding request according to XCAP, and the specific ring personal group adding request may be:

PUT http://server.crbt.com/service-setting/users/Tom/personalgroup1/~~/
group
HTTP/1.1
Content-Type: application/xml-fragment-body
<group >
<groupid>120</groupid>
<groupmembers>
<groupmember membernumber =”13822222222”>
< membername >Rose</ membername >
< memberdetail >Good friend</ memberdetail >
</groupmember>
<groupmember membernumber =” 13833333333”>
< membername >Jack</ membername >
</groupmember>
</groupmembers>
</group>

The above example indicates that one ring personal group is added under the user Tom, and that the ring personal group contains two ring group members, whose member numbers are respectively 13822222222 and 13833333333. Upon reception of the ring personal group adding request, the service sever newly adds a ring personal group under the user Tom, and adds the two ring group members in this ring personal group.

(3) The Process of Processing the Ring Group Member Adding Request:

In this mode, when the user intends to newly add a ring group member in a certain ring personal group, he inputs a ring personal group operating request to the management client, and the management client generates a corresponding ring group member adding request.

Upon acquisition of the ring personal group operating request, the management client generates a corresponding ring group member adding request according to XCAP, and the specific ring group member adding request may be:

PUT
http://server.crbt.com/service-setting/users/Tom/personalgroup1/~~/
group[groupid=“110”]/ groupmembers/
groupmember[membernumber=”13803”] HTTP/1.1

Content-Type: application/xml-fragment-body

The above example indicates that a ring group member with the member number of 13803 is added in the ring personal group with the group identifier of 110 of the user Tom. Upon reception of the ring group member adding request, the service server adds the ring group member with the member number of 13803 in the group with the group identifier of 110 of the user Tom.

(4) The Process of Processing the Ring Personal Group Modifying Request:

In this mode, when the user intends to modify a ring personal group, he inputs a ring personal group operating request to the management client, and the management client generates a corresponding ring personal group modifying request.

Upon acquisition of the ring personal group operating request, the management client generates a corresponding ring personal group modifying request according to XCAP, and the specific ring personal group modifying request may be:

PUT http://server.crbt.com/service-setting/users/Tom/
personalgroup1/group[groupid=”110”]/groupname HTTP/1.1
Content-Type: application/xml-fragment-body
< groupname >1111</ groupname >

The example above indicates that the group name of the ring personal group with the group identifier of 110 of the user Tom is modified to 1111. Upon reception of the ring personal group modifying request, the service server modifies the group name of the ring personal group with the group identifier of 110 of the user Tom to 1111.

(5) The Process of Processing the Ring Group Member Modifying Request:

In this mode, when the user intends to modify a ring group member in a certain ring personal group, he inputs a ring personal group operating request to the management client, and the management client generates a corresponding ring group member modifying request.

Upon acquisition of the ring personal group operating request, the management client generates a corresponding ring group member modifying request according to XCAP, and the specific ring group member modifying request may be:

PUT http://server.crbt.com/service-setting/users/Tom/
personalgroup1/group[groupid=”110”]/
groupmember[membernumber=”13802”]/member detail HTTP/1.1
Content-Type: application/xml-fragment-body
< memberdetail>friend</ memberdetail >

The example above indicates that the member description of the ring group member with the member number of 13802 in the ring personal group with the group identifier of 110 of the user Tom is modified to friend. Upon reception of the ring group member modifying request, the service server modifies the member description of the ring group member with the member number of 13802 in the ring personal group with the group identifier of 110 of the user Tom to friend.

(6) The Process of Processing the Ring Personal Group Deleting Request:

In this mode, when the user intends to delete a ring personal group, he inputs a ring personal group operating request to the management client, and the management client generates a corresponding ring personal group deleting request.

Upon acquisition of the ring personal group operating request, the management client generates a corresponding ring personal group deleting request according to XCAP, and the specific ring personal group deleting request may be:

DELETE http://server.crbt.com/service-setting/users/Tom/
personalgroup1 HTTP/1.1

The example above indicates that all ring personal groups of the user Tom are deleted. Upon reception of the ring personal group deleting request, the service server deletes all ring personal groups of the user Tom.

The ring personal group deleting request in this embodiment may also be:

DELETE
http://server.crbt.com/service-setting/users/Tom/personalgroup1/
group[groupid=“110”] HTTP/1.1

The example above indicates that the ring personal group with the group identifier of 110 of the user Tom is deleted. Upon reception of the ring personal group deleting request, the service server deletes the ring personal group with the group identifier of 110 of the user Tom.

(7) The Process of Processing the Ring Group Member Deleting Request:

In this mode, when the user intends to delete a certain ring group member from a certain ring personal group, he inputs a ring personal group operating request to the management client, and the management client generates a corresponding ring group member deleting request.

Upon acquisition of the ring personal group operating request, the management client generates a corresponding ring group member deleting request according to XCAP, and the specific ring group member deleting request may be:

DELETE
http://server.crbt.com/service-setting/users/Tom/personalgroup1/
group[groupid=“110”]/groupmember[membernumber =”13802”]
HTTP/1.1

The above example indicates that the ring group member with the member number of 13802 in the ring personal group with the group identifier of 110 of the user Tom is deleted. Upon reception of the ring group member deleting request, the service server deletes the ring group member with the member number of 13802 in the ring personal group with the group identifier of 110 of the user Tom.

As should be noted, in each of the aforementioned embodiments, the service server may be specifically embodied as a personalized ring service platform, or any other device capable of achieving similar functions, and in the XCAP mode, the service server should include an XML Database Management System (XDMS) with which the user processes XCAP.

In addition to the advantageous effects of the embodiments illustrated in FIGS. 1 and 2, in the technical solution of this embodiment the management client generates the ring personal group processing request in the mode of XCAP, and interacts with the service server through the XCAP, thereby making it possible to effectively reduce the amount of data transmitted between the client management terminal and the service server, to thereby save network resources.

As should be noted, in order to enhance safety in the process of processing ring personal groups, an access server may be further added in the embodiments of the present invention to authenticate the management client, and realize data forwarding between the management server and the service server. Specifically, the service processing method in which the access server participates according to the embodiments of the present invention may be divided into the following circumstances according to different scenarios of application.

### A. The Process of Processing a Ring Personal Group Querying Request:

In this mode, the access server authenticates the management client by receiving the ring personal group querying request transmitted by the management client over the mobile network, and judges whether there is locally stored the ring personal group information of the user to which the management client corresponds if the authentication is passed. If stored, the access server feeds back the locally stored ring personal group information to the management client over the mobile network; if not stored, the access server acquires the ring personal group information of the user from the service server, and feeds back the ring personal group information acquired from the service server to the management client over the mobile network.

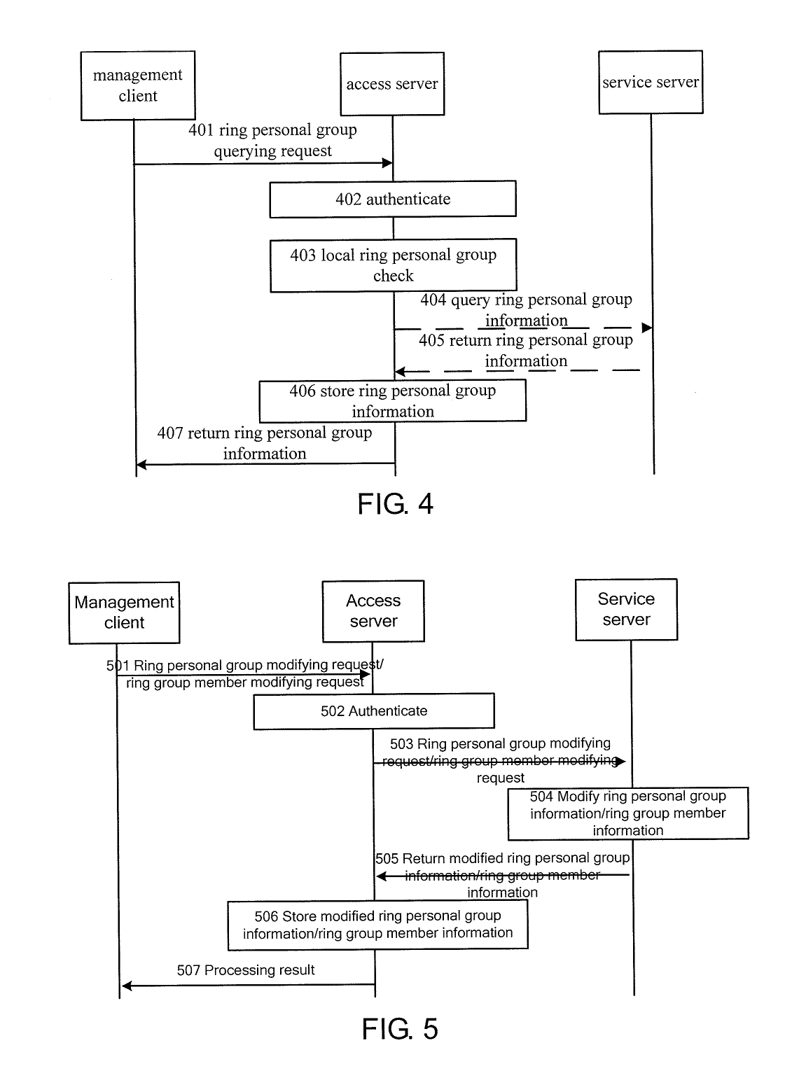

To facilitate comprehension, a concrete example is taken below to describe the aforementioned process. Referring to FIG. 4, yet another embodiment of the service processing method according to an embodiment of the present invention comprises the following steps:

Step 401: The management client transmits the ring personal group querying request to the access server.

In this mode, when the user intends to query the ring personal groups of his own, he may input a ring personal group operating request to the management client, and the management client generates a corresponding ring personal group querying request upon acquisition of the ring personal group operating request. The specific generating process may employ the HTTP mode, the XCAP mode, or any other mode, which is not defined here.

After generating the ring personal group querying request, the management client transmits the ring personal group querying request to the access server over the mobile network.

Step 402: The access server authenticates the management client.

Upon reception of the ring personal group querying request transmitted by the management client, the access server authenticates the user. If the authentication is passed, subsequent steps are executed; if the authentication fails, an authentication failure response is fed back to the management client.

The specific authenticating process may be to judge whether the user is authorized to query the ring personal group information, or may also be other types of authentication, which are not defined here.

As should be noted, in this embodiment, depending on the specific authenticating policy of the service operator, besides authenticating the user, the access server may also simultaneously authenticate the user terminal and/or the management client, or authenticate any two of the user, the management client, and the user terminal, or authenticate all three of them to execute subsequent operations only after the authentications are all passed.

Step 403: The access server performs local ring person group check.

After the authentication of the management client by the access server is passed, it may be judged whether the access server stores the ring personal group information queried by the management client in local. If stored, Step 407 is directly executed; if not stored, Steps 404 to 407 are executed.

Step 404: The access server requests the service server to acquire the ring personal group information.

If the access server does not store the ring personal group information queried by the management client in local, the access server acquires the ring personal group information from the service server. The specific acquiring mode may be to directly forward the ring personal group querying request transmitted by the management client to the service server.

Step 405: The service server returns the ring personal group information to the access server.

Upon reception of the ring personal group querying request transmitted by the access server, the service server returns the ring personal group information to be queried to the access server. The specific process for the service server to query is similar to the querying process described in the foregoing embodiment, and is hence not repeated here.

Step 406: The access server stores the ring personal group information.

After the access server acquires the ring personal group information from the service server, the ring personal group information may be locally stored, and then the management client may directly acquire the information locally from the access server when requesting to query the ring personal group information again in the future.

Step 407: The access server returns the ring personal group information to the management client.

When the access server locally stores the ring personal group information queried by the management client, or after the access server acquires the ring personal group information queried by the management client from the service server, the access server may return the ring personal group information to the management client.

In this embodiment, the access server may be realized independent of the service server, and dedicated to authenticate the management client, so that different access servers may be used for different accesses to authenticate and to manage, thereby enhancing flexibility of the authenticating process.

### B. The Process of Processing a Ring Personal Group Adjusting Request:

In this mode, the access server receives a ring personal group adjusting request transmitted by the management client over the mobile network. The specific ring personal group adjusting request may be a ring personal group modifying request/a ring group member modifying request, or a ring personal group deleting request/a ring group member deleting request.

The access server authenticates the management client. If the authentication is passed, the access server forwards the ring personal group adjusting request to the service server, and receives a ring personal group adjusting response fed back from the service server. The ring personal group adjusting response carries therewith ring personal group information/ring group member information updated by the service server.

The access server stores therein the ring personal group information/ring group member information in the ring personal group adjusting response, and feeds back the ring personal group information/ring group member information to the management client over the mobile network, or deletes the corresponding ring personal group/ring group member and feeds back the deleting result to the management client over the mobile network.

As should be noted, in this embodiment, depending on the specific authenticating policy of the service operator, besides authenticating the user, the access server may also simultaneously authenticate the user terminal and/or the management client, or authenticate any two of the user, the management client, and the user terminal, or authenticate all three of them to execute subsequent operations only after the authentications are all passed.

To facilitate comprehension, a concrete example is taken below to describe the aforementioned process. Referring to FIG. 5, still another embodiment of the service processing method according to an embodiment of the present invention comprises the following steps:

Step 501: The management client transmits the ring personal group modifying request/ring group member modifying request to the access server.

In this mode, when the user intends to modify a ring personal group or ring group member of his own, he may input a ring personal group operating request to the management client, and the management client generates a corresponding ring personal group modifying request/ring group member modifying request upon acquisition of the ring personal group operating request. The specific generating process may employ the HTTP mode, the XCAP mode, or any other mode, which is not defined here.

After generating the ring personal group modifying request/ring group member modifying request, the management client transmits the ring personal group modifying request/ring group member modifying request to the access server over the mobile network.

Step 502: The access server authenticates the management client.

Upon reception of the ring personal group modifying request/ring group member modifying request transmitted by the management client, the access server authenticates the user. If the authentication is passed, subsequent steps are executed; if the authentication fails, an authentication failure response is fed back to the management client.

The specific authenticating process may be to judge whether the user is authorized to modify the ring personal group information or ring group member information, and may also be other types of authentication, which are not defined here.

As should be noted, in this embodiment, depending on the specific authenticating policy of the service operator, besides authenticating the user, the access server may also simultaneously authenticate the user terminal and/or the management client, or authenticate any two of the user, the management client, and the user terminal, or authenticate all three of them to execute subsequent operations only after the authentications are all passed.

Step 503: The access server transmits the ring personal group modifying request/ring group member modifying request to the service server.

Step 504: The service server modifies the ring personal group information/ring group member information.

Upon reception of the ring personal group modifying request/ring group member modifying request transmitted by the access server, the service server modifies the corresponding ring personal group or ring group member according to the ring personal group modifying request/ring group member modifying request. The specific modifying process is similar to the modifying process described in the foregoing embodiments, and is hence not repeated here.

Step 505: The service server returns the modified ring personal group information/ring group member information to the access server.

After modifying the ring personal group information/ring group member information, the service server returns the modified ring personal group information/ring group member information to the access server.

Step 506: The access server stores the ring personal group information/ring group member information.

After the access server acquires the modified ring personal group information/ring group member information from the service server, the ring personal group information/ring group member information may be locally stored to realize local update of the ring personal group information/ring group member information, and then the management client may directly acquire the information locally from the access server when requesting to query the ring personal group information/ring group member information again in the future.

Step 507: The access server returns the processing result to the management client.

After the access server acquires the modified ring personal group information/ring group member information from the service server, it may return the processing result to the management client.

In this embodiment, the access server is realized independent of the service server, and dedicated to authenticate the management client, so that different access servers may be used for different accesses to authenticate and to manage, thereby enhancing flexibility of the authenticating process.

The process of processing the ring personal group deleting request/ring group member deleting request is similar to the process of processing the ring personal group modifying request/ring group member modifying request, and is hence not repeated here.

As should be noted, the service server in the foregoing embodiment may be embodied as a personalized ring service platform capable of simultaneously managing ring back tone service and ring tone service.

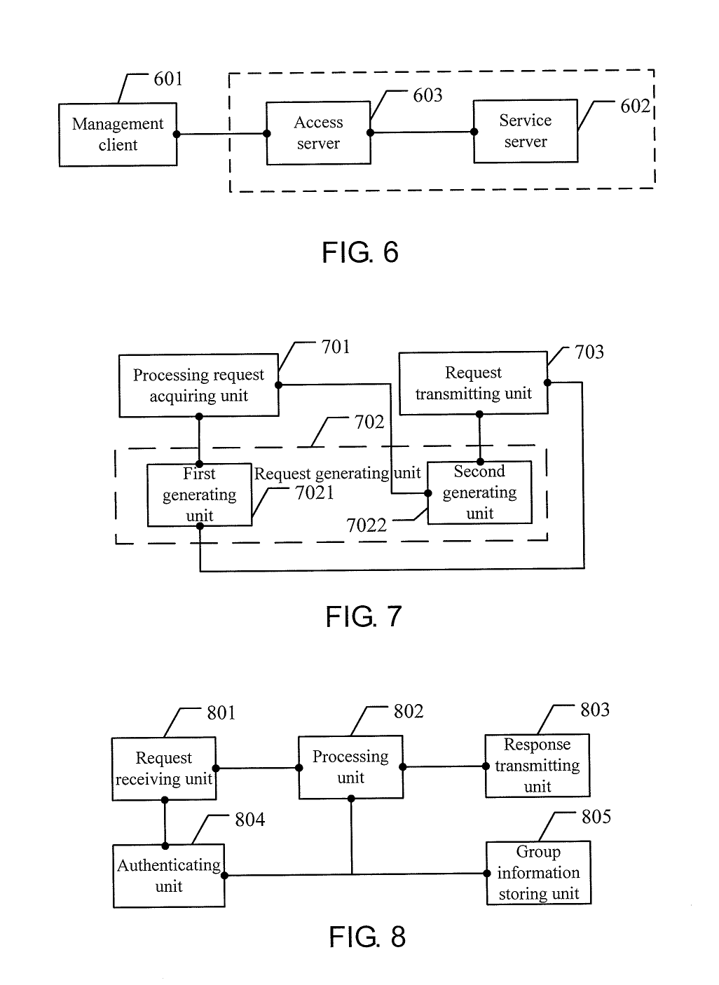

an embodiment of the communication system of an embodiment of the present invention is described below. Referring to FIG. 6, the communication system of an embodiment of the present invention comprises:

a management client 601, configured for acquiring a ring personal group operating request of a user, generating a ring personal group processing request according to the ring personal group operating request, and transmitting the ring personal group processing request to a service server 602 over a mobile network.

As should be noted, the mode whereby the ring personal group operating request is packaged may be different from the mode whereby the ring personal group processing request is packaged, as the ring personal group operating request may be a message transmitted inside the user terminal, while the ring personal group processing request may be a message transmitted between the management client 601 and the service server 602. In this embodiment, the management client 601 receives the ring personal group operating request inputted by the user from an input module of the user terminal, and subsequently packages the ring personal group operating request to generate the ring personal group processing request.

It can be understood that, in practical application, the management client 601 may likewise acquire the ring personal group processing request from the user, in which case the user inputs the ring personal group operating request via the input module of the user terminal, the ring personal group operating request may be packaged by another module, such as a transmission and package module, in the user terminal to generate the ring personal group processing request, and the management client 601 may then obtain the ring personal group processing request of the user.

If the management client 601 directly obtains the ring personal group processing request from the user in this embodiment, the process of generating the ring personal group processing request is not necessarily executed. Here, hereit is not defined whether the management client 601 should execute in local the process of generating the ring personal group processing request in practical application, and description is made in this embodiment merely by taking such an example that the management client 601 should execute in local the process of generating the ring personal group processing request.

A service server 602 is configured for receiving the ring personal group processing request transmitted by the management client 601 over the mobile network, and processing the corresponding ring personal group according to the ring personal group processing request.

The management client 601 in this embodiment may be disposed in the user terminal, and the service server 602 in this embodiment may be a personalized ring service platform or any other device capable of achieving similar functions.

The service server 602 in this embodiment is further used to feed back a ring personal group processing response to the management client 601.

The management client 601 is further used to receive the ring personal group processing response fed back by the service server 602.

In order to enhance safety of the querying process during the process of querying the ring personal group, the communication system in this embodiment may further include:

an access server 603, configured to receive a ring personal group querying request transmitted by the management client 601 over the mobile network, authenticate the management client 601, and judge whether there is locally stored the ring personal group information of the user to which the management client 601 corresponds if the authentication is passed. If stored, the access server 603 feeds back the locally stored ring personal group information to the management client 601 over the mobile network; if not stored, the access server 603 acquires the ring personal group information of the user from the service server 602, and feeds back the ring personal group information acquired from the service server 602 to the management client 601 over the mobile network.

In order to enhance safety of the modifying process during the process of modifying or deleting the ring personal group/modifying or deleting the ring group member, the communication system in this embodiment may further include:

an access server 603, configured to receive a ring personal group modifying request/ring group member modifying request transmitted by the management client 601 over the mobile network, authenticate the management client 601, forward the ring personal group modifying request/ring group member modifying request to the service server 602 if the authentication is passed, receive a ring personal group modifying response/ring group member modifying response fed back from the service server 602, where the ring personal group modifying response/ring group member modifying response carries therewith ring personal group information/ring group member information updated by the service server 602, store the ring personal group information/ring group member information updated by the service server 602, and feed back the ring personal group information/ring group member information updated by the service server 602 to the management client 601 over the mobile network.

To facilitate comprehension, the process of querying a ring personal group is taken for example below to describe the interaction of network elements in the communication system.

When the user intends to query the ring personal groups of his own, he may input a ring personal group operating request to the management client 601, and the management client 601 generates a corresponding ring personal group querying request upon acquisition of the ring personal group operating request. The specific generating process may employ the HTTP mode, the XCAP mode, or any other mode, which is not defined here.

After generating the ring personal group querying request, the management client 601 transmits the ring personal group querying request to the access server 603 over the mobile network.

Upon reception of the ring personal group querying request transmitted by the management client 601, the access server 603 authenticates the management client 601. If the authentication is passed, subsequent steps are executed; if the authentication fails, an authentication failure response is fed back to the management client 603.

The specific authenticating process may be judging whether the management client 601 is authorized to query the ring personal group of the user, and may also be other types of authentication, which are not defined here.

As should be noted, depending on the specific authenticating policy of the service operator, the access server may also authenticate the user and/or the user terminal, or authenticate any two of the user, the management client, and the user terminal, or authenticate all three of them to execute subsequent operations only after the authentications are all passed, so that it is possible to select different authenticating modes with regard to different service operators, thereby enhancing flexibility of the authenticating process.

After the authentication of the management client 601 by the access server 603 is passed, it may be judged whether the access server 603 stores the ring personal group information queried by the management client 601 in local. If the access server 603 does not store the ring personal group information queried by the management client 601 in local, the access server 603 acquires the ring personal group information from the service server 602. The specific acquiring mode may be: forwarding the ring personal group querying request transmitted by the management client 601 to the service server 602 directly.

Upon reception of the ring personal group querying request transmitted by the access server 603, the service server 602 returns the ring personal group information to be queried to the access server 603.

After the access server 603 acquires the ring personal group information from the service server 602, the ring personal group information may be locally stored, and then the management client 601 may directly acquire the information locally from the access server 603 when requesting to query the ring personal group information again in the future.

When the access server 603 locally stores the ring personal group information queried by the management client 601, or after the access server 603 acquires the ring personal group information queried by the management client 601 from the service server 602, the access server 603 may return the ring personal group information to the management client 601.

As should be noted, in the embodiment, the access server 603 and the service server 602 may either be integrally or independently realized in practical application, and if the independent realization mode is employed, different access servers 603 may be used for different accessing modes, thereby enhancing flexibility of the authenticating process.

An embodiment of the management client of an embodiment of the present invention is described below. Referring to FIG. 7, the management client in an embodiment of the present invention specifically comprises:

a processing request acquiring unit 701, configured for acquiring a ring personal group operating request of a user;

a request generating unit 702, configured for generating a ring personal group processing request according to the ring personal group operating request acquired by the processing request acquiring unit 701; and

a request transmitting unit 703, configured for transmitting the ring personal group processing request generated by the request generating unit 702 to a service server over a mobile network, so that the service server performs corresponding processing according to the ring personal group processing request.

As should be noted, if in this embodiment the processing request acquiring unit 701 may directly acquire the ring personal group processing request from the user (refer to the acquiring mode described in the foregoing embodiments for the specific acquiring mode), the management client of this embodiment may not need the request generating unit 702, namely it is unnecessary to generate the ring personal group processing request once again. Here, it is not defined whether the management client should execute in local the process of generating the ring personal group processing request in practical application, and description is made for this embodiment merely by taking such an example that the management client should execute in local the process of generating the ring personal group processing request, i.e., it is necessary for the request generating unit 702 to generate the ring personal group processing request.

When the request generating unit 702 is required in this embodiment, the request generating unit 702 may include at least one of:

a first generating unit 7021, configured for carrying parameters in the ring personal group operating request in a message head or message body of an HTTP message, and taking the HTTP message as the ring personal group processing request; and

a second generating unit 7022, configured for assembling an XCAP resource address and parameters in the ring personal group operating request into an extensible markup language configuration access protocol XCAP command, and taking the XCAP command as the ring personal group processing request.

Corresponding to the first generating unit 7021 or the second generating unit 7022, the request transmitting unit 703 of this embodiment employs HTTP or XCAP to transmit the ring personal group processing request to the service server over the mobile network.

The management client of this embodiment may further comprise a response receiving unit, configured for receiving a ring personal group processing response fed back by the service server over the mobile network.

To facilitate comprehension, cooperation amongst the units of the management client of this embodiment is described below with a scenario of application.

When the user intends to set up his ring personal group, he may perform such inputting operation as pressing a key to send the ring personal group operating request to the processing request acquiring unit 701 in the management client.

After the processing request acquiring unit 701 in the management client acquires the ring personal group operating request of the user, the request generating unit 702 generates a corresponding ring personal group processing request according to the ring personal group operating request in the mode of HTTP or XCAP, or any other mode, which is not defined here.

After the request generating unit 702 in the management client generates the ring personal group processing request, the request transmitting unit 703 may transmit the ring personal group processing request to the service server over the mobile network.

As should be noted, the management client of this embodiment may be placed in the user terminal, and uses the mobile network to transmit data to the service server by invoking the communication port of the user terminal. The management client is either preset with the network address of the service server or obtains the network address of the service serve from the terminal, so as to be able to transmit the data according to the address.

In this embodiment, after the processing request acquiring unit 701 receives the ring personal group operating request of the user, the request generating unit 702 generates the corresponding ring personal group processing request, and the request transmitting unit 703 directly transmits the ring personal group processing request to the service server over the mobile network without having to log in the website designated by the service operator, so that the direct interaction between the management client and the service server makes it easier for the user to set up and manage the ring personal groups at any time, and the process is not affected by failures of the website.

An embodiment of the service processing device of an embodiment of the present invention is described below. Referring to FIG. 8, the service processing device of an embodiment of the present invention specifically comprises:

a request receiving unit 801, configured for receiving a ring personal group processing request transmitted by a management client over a mobile network; and

a processing unit 802, configured for performing processing on a corresponding ring personal group according to the ring personal group processing request received by the request receiving unit 801.

The service processing device of this embodiment may further comprise a response transmitting unit 803, configured for feeding back a ring personal group processing response to the management client over the mobile network.

The service processing device of this embodiment may further comprise an authenticating unit 804, configured for authenticating at least one of a user, a user terminal, and the management client, and triggering the processing unit 802 to perform a corresponding operation if the authentication is passed.

The service processing device of this embodiment may further comprise a group information storing unit 805, configured for storing ring personal group information processed by the processing unit 802.

To facilitate comprehension, cooperation amongst the units of the service processing device of this embodiment is described below with a scenario of application.

In this embodiment, the management client may transmit the ring personal group processing request to the request receiving unit 801 in the service processing device over the mobile network, and the request receiving unit 801 in the service processing device of this embodiment may likewise receive the ring personal group processing request transmitted by the management client.

After the request receiving unit 801 in the service processing device receives the ring personal group processing request, the processing unit 802 may process the corresponding ring personal group of the user according to the request, including querying ring personal group, adding ring personal group, adding ring group member, modifying ring personal group, modifying ring group member, deleting ring personal group, deleting ring group member, or processing in other ways.

As should be noted, the service processing device of this embodiment may be the service server mentioned in the preceding embodiments, and may also be a service server integrated with the function of an access server, which is not defined here.

The modules of the service processing device may be integrated for arrangement in a same device, and may also be arranged independent of one other in different devices.

In this embodiment, the request receiving unit 801 in the service processing device may receive the ring personal group processing request transmitted by the management client over the mobile network, and the processing unit 802 performs the corresponding processing, so that the direct interaction between the management client and the service processing device makes it easier for the user to set up and manage the ring personal group at any time, and the process is not affected by failures of the website.

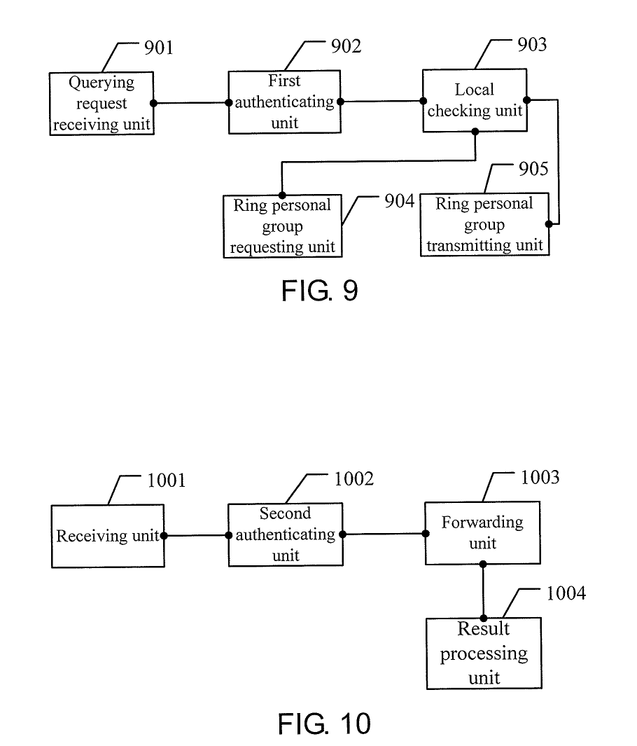

An embodiment of the access server of an embodiment of the present invention is described below. Referring to FIG. 9, the access server of an embodiment of the present invention used in the process of querying ring personal group specifically comprises:

a querying request receiving unit 901, configured for receiving a ring personal group querying request transmitted by the management client over the mobile network;

a first authenticating unit 902, configured for authenticating the management client;

a local checking unit 903, configured for judging, when the authenticating result of the first authenticating unit 902 is that the authentication is passed, whether there is locally stored ring personal group information of a user to which the management client corresponds;

a ring personal group requesting unit 904, configured for acquiring ring personal group information of the user from a service server when there is not locally stored the ring personal group information of the user to which the management client corresponds; and

a ring personal group transmitting unit 905, configured for transmitting locally stored ring personal group information to the management client over the mobile network.

As should be noted, in this embodiment, depending on the specific authenticating policy of the service operator, besides authenticating the management client, the first authenticating unit 902 may also simultaneously authenticate the user and/or the user terminal, or authenticate any two of the user, the management client, and the user terminal, or authenticate all three of them to execute subsequent operations only after the authentications are all passed.

Referring to FIG. 10, the access server of an embodiment of the present invention used in the process of modifying or deleting the ring personal group and/or modifying or deleting the ring group member specifically comprises:

a receiving unit 1001, configured for receiving a ring personal group adjusting request, which may be a ring personal group modifying request/ring group member modifying request, or a ring personal group deleting request/ring group member deleting request, transmitted by the management client over the mobile network;

a second authenticating unit 1002, configured for authenticating the management client;

a forwarding unit 1003, configured for forwarding, when the authenticating result of the second authenticating unit 1002 is that the authentication is passed, the ring personal group adjusting request received by the receiving unit 1001 to the service server, receiving a ring personal group adjusting response, which carries therewith ring personal group information/ring group member information updated by the service server or the deleting result, fed back from the service server, and feeding back the ring personal group information/ring group member information or the deleting result to the management client over the mobile network;

As should be noted, the forwarding unit 1003 of this embodiment may forward the ring personal group adjusting request transmitted by the management client to the service server, and may also transmit the ring personal group adjusting response to the management client. The response contains therewith the updated ring personal group information/ring group member information or the deleting result. In practical application, the two transmitting processes may be respectively carried out by different modules in the forwarding unit 1003.

a result processing unit 1004, configured for storing the ring personal group information/ring group member information updated by the service server, or deleting already stored personal group information/ring group member information.

As should be noted, in this embodiment, depending on the specific authenticating policy of the service operator, besides authenticating the management client, the second authenticating unit 1002 may also simultaneously authenticate the user and/or the user terminal, or authenticate any two of the user, the management client, and the user terminal, or authenticate all three of them to execute subsequent operations only after the authentications are all passed.

The technical solutions of the aforementioned embodiments possess the following advantageous effects:
(1) After receiving the ring personal group processing request of the user, the management client directly transmits the ring personal group processing request to the service server over the mobile network without having to log in the website designated by the service operator, so that the direct interaction between the management client and the service server makes it easier for the user to set up and manage the ring personal group at any time, and the process is not affected by failures of the website.
(2) Since the management client and the service server directly communicate without having to access the website, the management client will not receive from the service server any information irrelevant to the setup and management of the ring personal group, thus reducing unnecessary network traffic.
(3) The management client interacts with the service server over the mobile network without creating Internet connection with the service server, and since the characteristics of the mobile network itself decide that the safety of the mobile network is higher than that of the Internet, the mode of setting up and managing the ring personal group over the mobile network in the embodiments of the present invention effectively enhances system safety.
(4) The management client may transmit the ring personal group processing request to the service server via HTTP or XCAP, so that the specific transmitting process may employ a variety of protocols, thereby enhancing flexibility of the transmitting process.
(5) When XCAP is employed to transmit the ring personal group processing request, the amount of data transmitted is reduced due to the characteristics of XCAP, thereby saving transmission bandwidth.
(6) It is possible to carry out corresponding processing and authenticating by using different functions in the access server according to different circumstances, thereby enhancing flexibility of the authenticating process.
(7) Since the access server and/or the service server may authenticate at least one of the user, the user terminal, and the management client, flexibility of the authenticating process may be further enhanced.

As comprehensible to persons ordinarily skilled in the art, the entire or partial steps in the aforementioned method embodiments may be carried out through hardware related to program instructions, and the program may be stored in a computer-readable storage medium. When being executed, the program executes the steps of the aforementioned method embodiments. The storage medium includes media capable of storing program codes, such as an ROM, an RAM, a magnetic disk or an optical disk.

The above describes in detail the service processing method, the communication system, and the related device provided by the present invention. To a person ordinarily skilled in the art, there would be modifications in both the mode of execution and the scope of application without departing from the principles manifested in the embodiments of the present invention. In summary, the contents of the Description should not be understood as restrictive of the present invention.

1. A service processing method, comprising:
acquiring, by a management client, a ring personal group processing request of a user; and
transmitting, by the management client, the ring personal group processing request to a service server over a mobile network, so that the service server performs the corresponding processing according to the ring personal group processing request.

2. The method according to claim 1, wherein transmitting, by the management client, the ring personal group processing request to a service server over a mobile network comprising:
using hypertext transfer protocol HTTP or extensible markup language configuration access protocol XCAP, by the management client, to transmit the ring personal group processing request to the service server over the mobile network.

3. The method according to claim 1, further comprising after the ring personal group processing request is transmitted by the management client to the service server over the mobile network,
processing, by the service server, a corresponding ring personal group according to the ring personal group processing request; and
feeding back, by the service server, a ring personal group processing response to the management client over the mobile network, the ring personal group processing response carrying therewith a processing result.

4. The method according to claim 3, wherein, when XCAP is used by the management client to transmit the ring personal group processing request to the service server over the mobile network, the method further comprises:
managing, by the service server, the ring personal group using a document form of extensible markup language XML.

5. The method according to claim 1, wherein:
the ring personal group processing request carries therewith a user identifier of the user who initiates the ring personal group processing request.

6. The method according to claim 5, wherein the ring personal group processing request further includes at least one of the following parameters:
an addition identifier, a modify identifier, a target identifier, and a deletion identifier;
the ring personal group processing request is a ring personal group querying request that carries therewith a user identifier; or
the ring personal group processing request is a ring personal group adding request or a ring group member adding request that carries therewith the addition identifier; or
the ring personal group processing request is a ring personal group modifying request or a ring group member modifying request that carries therewith the modify identifier and the target identifier; or
the ring personal group processing request is a ring personal group deleting request or a ring group member deleting request that carries therewith the deletion identifier.

7. The method according to claim 1, further comprising:
synchronizing the management client with the service server;
receiving, by the management client, ring personal group information stored in the service server and transmitted from the service server; and
presenting, by the management client, the ring personal group information to the user.

8. A communication system, comprising:
a management client, configured to acquire a ring personal group processing request of a user, and transmit the ring personal group processing request to a service server over a mobile network; and
the service server, configured to receive the ring personal group processing request transmitted by the management client over the mobile network, and perform processing on a corresponding ring personal group according to the ring personal group processing request.

9. A management client, comprising:
a processing request acquiring unit, configured to acquire a ring personal group processing request of a user; and
a request transmitting unit, configured to transmit the ring personal group processing request acquired by the processing request acquiring unit to a service server over a mobile network, so that the service server performs corresponding processing according to the ring personal group processing request.

10. The management client according to claim 9, wherein the request transmitting unit uses HTTP or XCAP to transmit the ring personal group processing request to the service server over the mobile network.

11. A service processing device, comprising:
a request receiving unit, configured to receive a ring personal group processing request transmitted by a management client over a mobile network; and
a processing unit, configured to perform processing on a corresponding ring personal group according to the ring personal group processing request received by the request receiving unit.

12. The service processing device according to claim 11, further comprising at least one of:
a response transmitting unit, configured to feed back a ring personal group processing response to the management client over the mobile network;
an authenticating unit, configured to authenticate at least one of a user who initiates the ring personal group processing request, a user terminal, and the management client, and trigger the processing unit to perform a corresponding operation if the authentication is passed; and
a storing unit, configured to store ring personal group information/ring group member information processed by the processing unit.
